(19) United States
(12) Patent Application Publication
(10) Pub. No.: US 2016/0252435 A1
(43) Pub. Date: Sep. 1, 2016

(54) SOLID PHASE EXTRACTION CARTRIDGE

(71) Applicant: AISTI SCIENCE CO., LTD., Wakayama-shi, Wakayama (JP)

(72) Inventor: Ryoichi SASANO, Wakayama-shi (JP)

(73) Assignee: AiSTI SCIENCE CO., Ltd., Wakayama-shi (JP)

(21) Appl. No.: 15/029,873

(22) PCT Filed: Sep. 18, 2014
(86) PCT No.: PCT/JP2014/074678

§ 371 Date: Apr. 15, 2016

(30) Foreign Application Priority Data
Oct. 18, 2013 (JP) 2013-217547

(51) Int. Cl. G01N 1/40; B01D 15/22; G01N 30/14

(52) U.S. Cl. CPC G01N 1/4005; G01N 30/14; B01D 15/22

(57) ABSTRACT

Provided is a solid phase extraction cartridge including a front end portion for discharging in a cartridge main body, which is capable of connecting a pipe without using a connection adapter and is preferable for an extremely small amount filling type with high analysis accuracy.

A solid phase extraction cartridge 1 is configured by, in a cylindrical cartridge main body 2, attaching a sample outflow-side frit 3, filling a portion above the sample outflow-side frit 3 with a solid phase filler 4, and causing a sample inflow-side frit 5 to abut against and be pressed on the solid phase filler 4 to be capped, and is provided with a cylindrical front end portion for discharging 6 under the sample outflow-side frit 3 in the cartridge main body 2. In the solid phase extraction cartridge 1, an inner surface 7B of the front end portion for discharging 6 is formed into a tapered shape of being decreased in diameter toward the upper side, and a pipe PO inserted into the front end portion for discharging 6 from the lower side makes close contact with an upper portion of the inner surface 7B. Therefore, the pipe PO can be connected easily and reliably without using a connection adapter. This largely reduces a dead space and an eluting solution therefore flows smoothly with no waste, thereby increasing analysis accuracy.

### TECHNICAL FIELD

The present invention relates to a solid phase extraction cartridge that is used for preparing a sample to be analyzed by liquid chromatograph, gas chromatograph, or the like.

### BACKGROUND ART

Solid phase extraction (SPE) is a method for separating an analysis target substance and impurities other than the analysis target substance that are contained in a solution or a suspension in analytical chemistry, and a solid phase extraction cartridge filled with a solid phase carrier is used therefor.

Such a solid phase extraction cartridge is configured by, in a cylindrical cartridge main body (reservoir), attaching a disc-shaped sample outflow-side frit (filter), filling a portion above the sample outflow-side frit (filter) with a solid phase filler (adsorbent), and causing a disc-shaped sample inflow-side frit (filter) to abut against and be pressed on the solid phase filler (adsorbent), and is capped (for example, see Patent Documents 1 and 2).

A sample is injected into the solid phase extraction cartridge configured as described above using a syringe (injector), for example, so as to cause an analysis target substance (target component) in the injected sample to be held by the solid phase filler. Furthermore, an eluting solution is made to flow into the solid phase filler holding the analysis target substance so as to collect the condensed analysis target substance.

In the solid phase extraction cartridge as disclosed in Patent Document 1, as in a solid phase extraction cartridge 11 as illustrated in a longitudinal cross-sectional view in FIG. 6, a cylindrical front end portion for discharging 6 having a smaller diameter than the diameter of a cylindrical cartridge main body 2 is formed at the discharge side (under a sample outflow-side frit 3) in the cartridge main body 2 and a pipe is connected to the solid phase extraction cartridge 11 using a connection adapter A that is externally fitted with the front end portion for discharging 6.

In the solid phase extraction cartridge as disclosed in Patent Document 2, the front end portion for discharging is not provided in order to enable a plurality of solid phase extraction cartridges to be easily coupled at upper and lower multiple stages and a pipe is therefore connected to the solid phase extraction cartridge using a connection adapter that is externally fitted with a lower portion of a cylindrical cartridge main body.

### CITATION LIST

### Patent Literatures

Patent Document 1: JP-A No. 2002-316002

Patent Document 2: Japanese Patent No. 4285387

### SUMMARY OF INVENTION

### Technical Problem

The configurations of the existing solid phase extraction cartridges as disclosed in Patent Documents 1 and 2 require the connection adapter for connecting the pipe.

Furthermore, in the configuration of the solid phase extraction cartridge as disclosed in Patent Document 1, the inside of the front end portion for discharging is a dead space (see, dead space D in FIG. 6) in a state where the pipe is connected using the connection adapter.

In particular, when an extremely small amount filling-type solid phase extraction cartridge, which is suitable for measurement of an extremely small amount of analysis target substance (target substance) with recent development of the analysis technology, is used, the initial eluting solution contains almost all the analysis target substances. When the eluting solution pools in the dead space or leaks, analysis accuracy is deteriorated.

In addition, it is difficult to incorporate the disc-shaped sample outflow-side frit and sample inflow-side frit in the extremely small amount filling-type solid phase extraction cartridge, which has a small inner diameter (for example, inner diameter of approximately 2 mm), in particular.

In view of the above-described circumstances, an object of the present invention is to provide a solid phase extraction cartridge including a front end portion for discharging in a cartridge main body, which is capable of connecting a pipe without using a connection adapter, exerts high analysis accuracy with a reduced dead space, enables a frit to be easily incorporated into a cartridge main body, and is preferable for an extremely small amount filling type.

### Solution to Problem

In order to achieve the above-described object, a solid phase extraction cartridge according to an aspect of the invention is configured by, in a cylindrical cartridge main body, attaching a sample outflow-side frit, filling a portion above the sample outflow-side frit with a solid phase filler, and causing a sample inflow-side frit to abut against and be pressed on the solid phase filler to be capped, and is provided with a cylindrical front end portion for discharging under the sample outflow-side frit in the cartridge main body, wherein an inner surface of the front end portion for discharging is formed into a tapered shape of being decreased in diameter toward a sample inflow side, and a pipe inserted into the front end portion for discharging from a sample outflow side makes close contact with the inner surface at the sample inflow side.

In order to achieve the above-described object, a solid phase extraction cartridge according to another aspect of the invention is configured by, in a cylindrical cartridge main body, attaching an integrated solid phase extraction body having a multiple continuous hole or being porous, and is provided with a cylindrical front end portion for discharging at a sample outflow side of the solid phase extraction body in the cartridge main body, wherein an inner surface of the front end portion for discharging is formed into a tapered shape of being decreased in diameter toward a sample inflow side, and a pipe inserted into the front end portion for discharging from the sample outflow side makes close contact with the inner surface at the sample inflow side.

With the configuration of the solid phase extraction cartridge, the inner surface of the front end portion for discharging is formed into the tapered shape of being decreased in diameter toward the sample inflow side. Therefore, when the pipe is inserted into the front end portion for discharging from the sample outflow side, the pipe makes close contact with the inner surface of the front end portion for discharging. This enables the pipe to be connected easily and reliably without using a connection adapter.

In addition, the pipe inserted into the front end portion for discharging from the sample outflow side makes close contact with the inner surface of the front end portion for discharging at the sample inflow side. This largely reduces a dead space in comparison with the dead space D in FIG. 6 and an eluting solution therefore flows smoothly with no waste, thereby increasing analysis accuracy.

It is preferable that an inner surface of the cartridge main body at the sample inflow side relative to the sample inflow-side frit or an inner surface of the cartridge main body at the sample inflow side relative to the solid phase extraction body be formed into a tapered shape of being decreased in diameter toward the sample outflow side, and the pipe inserted into the cartridge main body from the sample inflow side make close contact with the inner surface at the sample outflow side.

With this configuration, the sample inflow-side inner surface of the cartridge main body is formed into the tapered shape of being decreased in diameter toward the sample outflow side. Therefore, when the pipe is inserted into the cartridge main body from the sample inflow side, the pipe makes close contact with the sample inflow-side inner surface of the cartridge main body at the sample outflow side.

Accordingly, the sample is not dispersed in the dead space before it reaches the solid phase filler or the solid phase extraction body and even a small amount of sample (for example, approximately 5 μL) can be loaded on the solid phase immediately, thereby exerting high efficiency.

Furthermore, it is preferable that the sample outflow-side frit be formed as a spherical body and a partially spherical receiving surface along which the sample outflow-side frit is disposed be formed in the cartridge main body.

With this configuration, the sample outflow-side frit is formed as the spherical body. Therefore, the sample outflow-side frit is not required to be incorporated into the cartridge main body in consideration of a posture thereof unlike a disc-shaped frit. This makes an incorporation operation easy and the characteristic is significant in the extremely small amount filling-type solid phase extraction cartridge, which has a small inner diameter (for example, inner diameter of approximately 2 mm), in particular.

In addition, the spherical-shaped sample outflow-side frit is disposed along the partially spherical receiving surface in the cartridge main body. Therefore, no dead space is formed and analysis accuracy is not deteriorated.

Furthermore, it is preferable that the sample inflow-side frit be formed as a spherical body having a diameter same as a diameter of the sample outflow-side frit, and the sample outflow-side frit and the sample inflow-side frit be commonly formed.

With this configuration, the sample inflow-side frit is formed as the spherical body. Therefore, the sample inflow-side frit is not required to be incorporated into the cartridge main body in consideration of a posture thereof unlike a disc-shaped frit. This makes an incorporation operation of the sample inflow-side frit into the cartridge main body easy and the characteristic is significant in the extremely small amount filling-type solid phase extraction cartridge, which has a small inner diameter (for example, inner diameter of approximately 2 mm), in particular.

Moreover, the sample outflow-side frit and the sample inflow-side frit are not required to be distinguished from each other because they are formed as the spherical bodies having the same diameter. This further makes the incorporation operation of them into the cartridge main body easy.

### Advantageous Effects of Invention

As described above, the solid phase extraction cartridge according to the present invention provide the following significant effects:

a) the pipe can be connected easily and reliably without using a connection adapter because the pipe is connected by being inserted into the front end portion for discharging having the inner surface which is formed into the tapered shape of being decreased in diameter toward the sample inflow side from the sample outflow side;

b) the eluting solution flows smoothly with no waste and analysis accuracy is therefore increased because the pipe makes close contact with the inner surface of the front end portion for discharging at the sample inflow side so as to largely reduce a dead space;

c) even a small amount of sample can be loaded on the solid phase immediately and high efficiency is exerted because when the pipe is inserted into the cartridge main body having the inner surface which is formed into the tapered shape of being decreased in diameter toward the sample outflow side from the sample inflow side, the pipe makes close contact with the sample inflow-side inner surface of the cartridge main body at the sample outflow side; and

d) the incorporation operation of the frits into the cartridge main body is very easy in the extremely small amount filling-type solid phase extraction cartridge, which has a small inner diameter, in particular, when the frits are formed as the spherical bodies.

### BRIEF DESCRIPTION OF THE DRAWINGS

FIG. 1 is a longitudinal cross-sectional view illustrating a state where a pipe is connected to a solid phase extraction cartridge according to a first embodiment of the invention.

FIG. 2 is a longitudinal cross-sectional view of the solid phase extraction cartridge in the first embodiment of the invention.

FIG. 3 is a longitudinal cross-sectional view of a solid phase extraction cartridge according to a second embodiment of the invention.

FIG. 4 is a longitudinal cross-sectional view of a solid phase extraction cartridge according to a third embodiment of the invention.

FIG. 5 illustrates variations of a shape of a cartridge main body, FIG. 5(a) illustrates an example in which the cartridge main body is configured by two parts of a base portion and an upper portion and FIG. 5(b) illustrates an example in which the cartridge main body is formed into an injection syringe shape.

FIG. 6 is a longitudinal cross-sectional view illustrating a state where a connection adapter is attached to an existing solid phase extraction cartridge.

### DESCRIPTION OF EMBODIMENTS

Next, embodiments of the present invention will be described in detail with reference to the accompanying drawings.

### First Embodiment

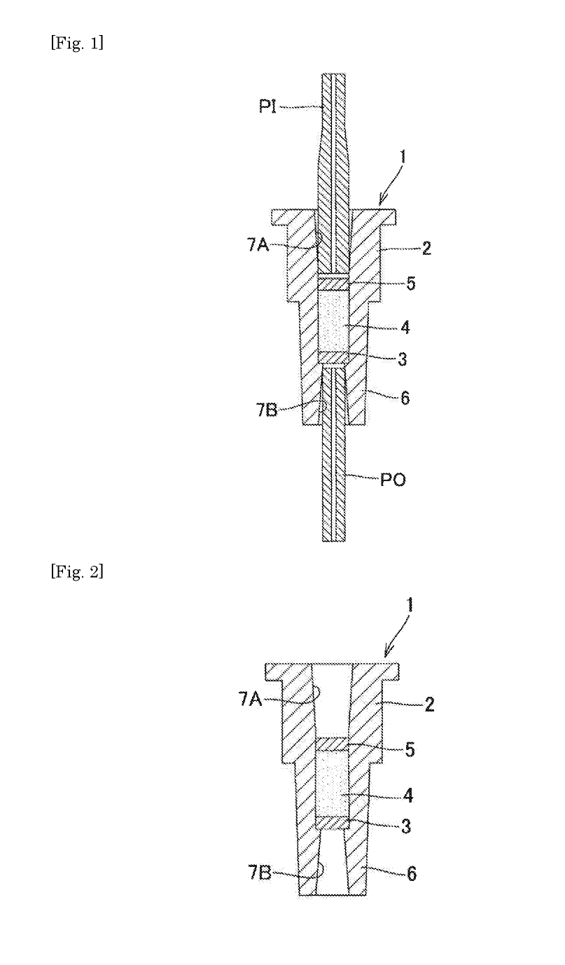

As illustrated in longitudinal cross-sectional views in FIG. 1 and FIG. 2, a solid phase extraction cartridge 1 according to a first embodiment of the invention is configured by, in a cylindrical cartridge main body 2 made of semi-transparent synthetic resin, attaching a disc-shaped sample outflow-side frit 3 made of synthetic resin, filling a portion above the sample outflow-side frit 3 with a solid phase filler 4, and causing a disc-shaped sample inflow-side frit 5 made of synthetic resin to abut against and be pressed on the solid phase filler 4 to be capped. The solid phase extraction cartridge 1 is provided with a cylindrical front end portion for discharging 6 under (at the sample outflow side of) the sample outflow-side frit 3 in the cartridge main body 2.

The outer shape of a horizontal cross section of the cartridge main body 2 is not limited to a circular shape and may be a shape other than the circular shape, such as a polygonal shape. However, as for a hole in the up-down direction in the cartridge main body 2, the outer shapes of horizontal cross sections of at least a portion from the upper disc-shaped frit 5 to the lower disc-shaped frit 3 and the front end portion for discharging 6 are circular holes.

An inner surface 7B of the front end portion for discharging 6 is formed into a tapered shape (a gradient thereof is approximately 3 to 5 degrees) of being decreased in diameter toward the upper side (toward the sample inflow side). A pipe PO inserted into the front end portion for discharging 6 from the lower side (sample outflow side) as illustrated in FIG. 1 makes close contact with an upper portion of the inner surface 7B of the front end portion for discharging 6 (the inner surface 7B at the sample inflow side in the vicinity of the disc-shaped sample outflow-side frit 3).

Furthermore, an inner surface 7A of the cartridge main body 2 at the upper side (sample inflow side) relative to the sample inflow-side frit 5 in the cartridge main body 2 is formed into a tapered shape (a gradient thereof is approximately 3 to 5 degrees) of being decreased in diameter toward the lower side (sample outflow side). A pipe PI inserted into the cartridge main body 2 from the upper side (sample inflow side) as illustrated in FIG. 1 makes close contact with a lower portion of the inner surface 7A (the inner surface 7A at the sample outflow side in the vicinity of the disc-shaped sample inflow-side frit 5).

It should be noted that the pipes PI and PO are made of stainless steel, PEEK, or PTFE.

Although examples of a material of the solid phase filler 4 include silica gel, alumina, octadecyl silica, sodium sulfate, and polymer-based exchange resin, another material may be used. The material can be appropriately selected in accordance with foreign substances to be removed, a type of the analysis target substance (target component) to be held, and the like.

The solid phase extraction cartridge 1 is of an extremely small amount filling-type and a filled amount of the solid phase filler 4 is approximately 2 to 50 mg.

With the configuration of the solid phase extraction cartridge 1 as in the first embodiment, the inner surface 7B of the front end portion for discharging 6 is formed into the tapered shape of being decreased in diameter toward the upper side (sample inflow side). Therefore, when the pipe PO is inserted into the front end portion for discharging 6 from the lower side (sample outflow side), the pipe PO makes close contact with the inner surface 7B of the front end portion for discharging 6, thereby connecting the pipe PO easily and reliably without using a connection adapter.

Furthermore, the pipe PO inserted into the front end portion for discharging 6 from the lower side (sample outflow side) makes close contact with the upper portion of the inner surface 7B of the front end portion for discharging 6 (the inner surface 7B at the sample inflow side). This largely reduces a dead space in comparison with the dead space D in FIG. 6 and an eluting solution therefore flows smoothly with no waste, thereby increasing analysis accuracy.

In addition, the sample inflow-side inner surface 7A of the cartridge main body 2 is formed into the tapered shape of being decreased in diameter toward the lower side (sample outflow side). Therefore, when the pipe PI is inserted into the cartridge main body 2 from the sample inflow side, the pipe PI makes close contact with the sample inflow-side inner surface 7A of the cartridge main body 2, thereby connecting the pipe PI easily and reliably without using a connection adapter.

Furthermore, the pipe PI inserted into the cartridge main body 2 from the upper side (sample inflow side) makes close contact with the lower portion of the sample inflow-side inner surface 7A (the inner surface 7A at the sample outflow side). Accordingly, the sample is not dispersed in the dead space before it reaches the solid phase filler 4 and even a small amount of sample (for example, approximately 5 μL) can be loaded on the solid phase immediately, thereby exerting high efficiency.

### Second Embodiment

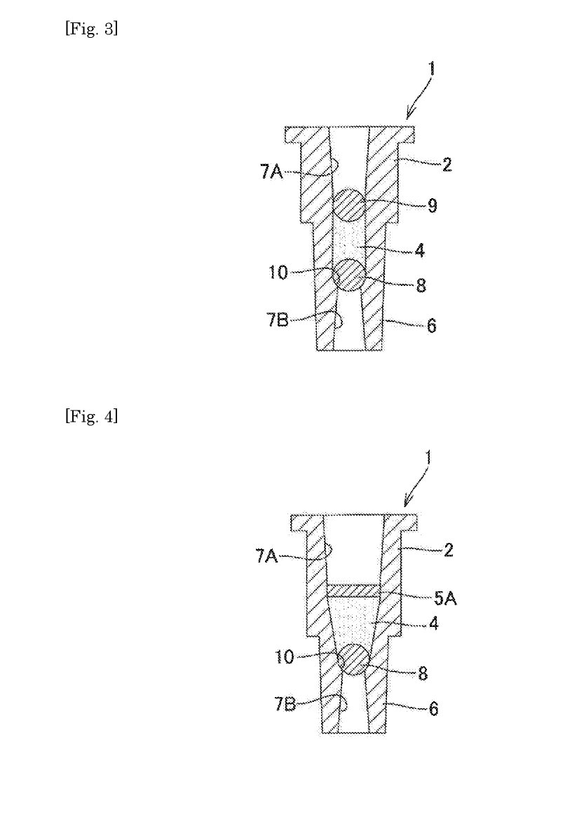

As illustrated in a longitudinal cross-sectional view in FIG. 3, a solid phase extraction cartridge 1 according to a second embodiment of the invention is different from the solid phase extraction cartridge 1 in the first embodiment in points that a spherical-shaped sample outflow-side frit 8 and a spherical-shaped sample inflow-side frit 9 are used and a partially spherical receiving surface 10 along which the spherical-shaped sample outflow-side frit 8 is disposed is formed in the cartridge main body 2. Other configurations thereof are the same as those in the first embodiment and the same reference numerals as those in FIG. 2 in the first embodiment denote the same or corresponding portions.

It should be noted that the spherical-shaped sample outflow-side frit 8 and the spherical-shaped sample inflow-side frit 9 have the same diameter.

With the configuration of the solid phase extraction cartridge 1 as in the second embodiment, the sample outflow-side frit 8 and the sample inflow-side frit 9 are formed as the spherical bodies. Therefore, the sample outflow-side frit 8 and the sample inflow-side frit 9 are not required to be incorporated into the cartridge main body 2 in consideration of postures thereof unlike the disc-shaped frits 3 and 5. This makes an incorporation operation thereof very easy and the characteristic is significant in the extremely small amount filling-type solid phase extraction cartridge 1, which has a small inner diameter (for example, inner diameter of approximately 2 mm), in particular.

Moreover, the sample outflow-side frit 8 and the sample inflow-side frit 9 are not required to be distinguished from each other because they are formed as the spherical bodies having the same diameter. This further makes the incorporation operation thereof into the cartridge main body 2 easy.

In addition, the spherical-shaped sample outflow-side frit 8 is disposed along the partially spherical receiving surface 10 of the cartridge main body 2. Therefore, no dead space is formed and analysis accuracy is not deteriorated.

### Third Embodiment

As illustrated in a longitudinal cross-sectional view in FIG. 4, a solid phase extraction cartridge 1 according to a third embodiment of the invention has the same configuration as that of the solid phase extraction cartridge 1 in FIG. 3 in the second embodiment other than a point that a disc-shaped sample inflow-side frit 5A is used.

The solid phase extraction cartridge 1 in the third embodiment has a configuration in which the diameter of the disc-shaped sample inflow-side frit 5A is made larger than, for example, approximately twice the diameter of the spherical-shaped sample outflow-side frit 8. In the extremely small amount filling-type solid phase extraction cartridge, the inner surface of a circular hole in the cartridge main body 2 is formed such that the inner diameter of the circular hole is made large at a height position of the disc-shaped sample inflow-side frit 5A. Therefore, an incorporation operation of the disc-shaped sample inflow-side frit 5A is relatively easy.

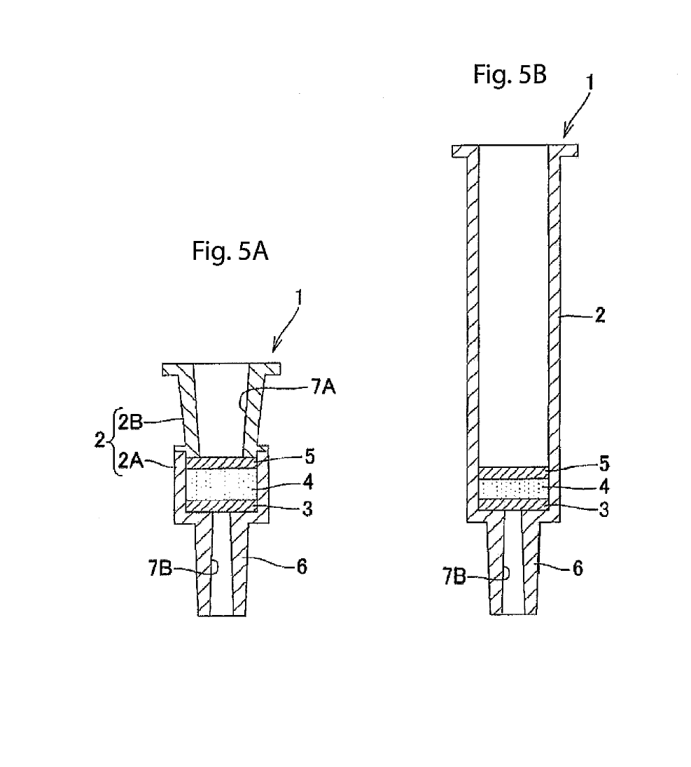

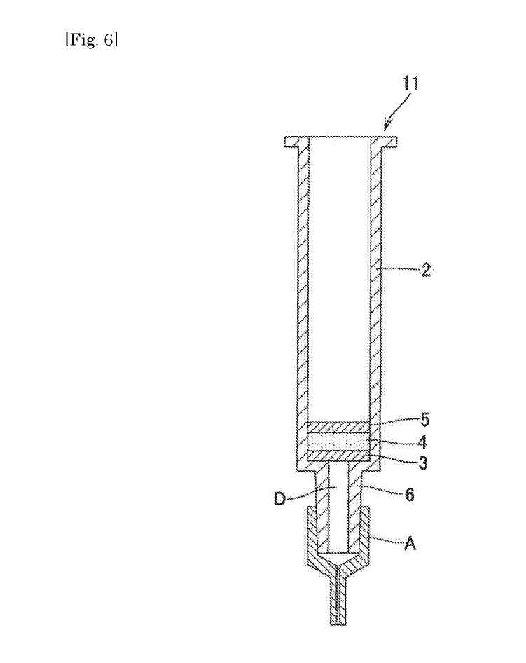

In the solid phase extraction cartridge 1 of the invention, the shape of the cartridge main body 2 is not limited to those in the first to third embodiments. Alternatively, as illustrated in a longitudinal cross-sectional view in FIG. 5(a), the cartridge main body may be configured by two parts of a base portion 2A and an upper portion 2B.

With this configuration, the sample outflow-side frit 3, the solid phase filler 4, and the sample inflow-side frit 5 are put into the base portion 2A, and then, the upper portion 2B is bonded onto the base portion 2A.

Alternatively, the cartridge main body 2 may be formed into an injection syringe shape as illustrated in a longitudinal cross-sectional view in FIG. 5(b) or may be formed into another shape.

Although the frits (filters) are used in the above description, when an integrated solid phase extraction body having a multiple continuous hole or being porous is made to hold the analysis target substance (target component), the frits become unnecessary because the solid phase extraction body is solid.

The configuration of the invention in this case corresponds to the configuration in which an inner surface of a front end portion for discharging is formed into a tapered shape of being decreased in diameter toward the sample inflow side, and a pipe inserted into the front end portion for discharging from the sample outflow side makes close contact with the inner surface at the sample inflow side in a solid phase extraction cartridge like MonoSpin (registered trademark) manufactured by GL Sciences Inc.

Even with the configuration, the pipe PO can be connected easily and reliably without using a connection adapter and the pipe inserted into the front end portion for discharging from the lower side (sample outflow side) makes close contact with an upper portion of the inner surface of the front end portion for discharging (the inner surface of the front end portion for discharging at the sample inflow side). This largely reduces a dead space in comparison with the dead space D in FIG. 6 and an eluting solution therefore flows smoothly with no waste, thereby increasing analysis accuracy.

It should be noted that the integrated solid phase extraction body may be used for the solid phase extraction cartridge 1 as in the first embodiment (FIG. 2).

### REFERENCE SIGNS LIST

1, 11 Solid phase extraction cartridge
2 Cartridge main body
2A Base portion
2B Upper portion
3 Disc-shaped sample outflow-side frit
4 Solid phase filler
5, 5A Disc-shaped sample inflow-side frit
6 Front end portion for discharging
7A, 7B Inner surface
8 Spherical-shaped sample outflow-side frit
9 Spherical-shaped sample inflow-side frit
10 Receiving surface
A Connection adapter
D Dead space
PI, PO Pipe

1: A solid phase extraction cartridge which is configured by, in a cylindrical cartridge main body, attaching a sample outflow-side frit, filling a portion above the sample outflow-side frit with a solid phase filler, and causing a sample inflow-side frit to abut against and be pressed on the solid phase filler to be capped, and is provided with a cylindrical front end portion for discharging under the sample outflow-side fit in the cartridge main body,
wherein an inner surface of the front end portion for discharging is formed into a tapered shape of being decreased in diameter toward a sample inflow side, and a pipe inserted into the front end portion for discharging from a sample outflow side makes close contact with the inner surface at the sample inflow side.

2: A solid phase extraction cartridge which is configured by, in a cylindrical cartridge main body, attaching an integrated solid phase extraction body having a multiple continuous hole or being porous, and is provided with a cylindrical front end portion for discharging at a sample outflow side of the solid phase extraction body in the cartridge main body,
wherein an inner surface of the front end portion for discharging is formed into a tapered shape of being decreased in diameter toward a sample inflow side, and a pipe inserted into the front end portion for discharging from the sample outflow side makes close contact with the inner surface at the sample inflow side.

3: The solid phase extraction cartridge according to claim 1,
wherein an inner surface of the cartridge main body at the sample inflow side relative to the sample inflow-side fit or an inner surface of the cartridge main body at the sample inflow side relative to the solid phase extraction body is formed into a tapered shape of being decreased in diameter toward the sample outflow side, and the pipe inserted into the cartridge main body from the sample inflow side makes close contact with the inner surface at the sample outflow side.

4: The solid phase extraction cartridge according to claim 1,
wherein the sample outflow-side frit is formed as a spherical body and a partially spherical receiving surface along which the sample outflow-side frit is disposed is formed in the cartridge main body.

5: The solid phase extraction cartridge according to claim 4,
wherein the sample inflow-side fit is formed as a spherical body having a diameter same as a diameter of the sample outflow-side frit, and the sample outflow-side fit and the sample inflow-side fit are commonly formed.

6: The solid phase extraction cartridge according to claim 2,
wherein an inner surface of the cartridge main body at the sample inflow side relative to the sample inflow-side frit or an inner surface of the cartridge main body at the sample inflow side relative to the solid phase extraction body is formed into a tapered shape of being decreased in diameter toward the sample outflow side, and the pipe inserted into the cartridge main body from the sample inflow side makes close contact with the inner surface at the sample outflow side.
